(19) United States
(12) Patent Application Publication
(10) Pub. No.: US 2004/0247899 A1
(43) Pub. Date: Dec. 9, 2004

(54) Process for the production of non-fogging scratch-resistant laminate

(76) Inventors: Peter Bier, Krefeld (DE); Peter Capellen, Krefeld (DE)

Correspondence Address: BAYER MATERIAL SCIENCE LLC, 100 BAYER ROAD, PITTSBURGH, PA, 15205, US

(21) Appl. No.: 10/858,900

(22) Filed: Jun. 2, 2004

(30) Foreign Application Priority Data
Jun. 5, 2003 (DE) 10325436.6

(51) Int. Cl. B32B 19/00

(52) U.S. Cl. 428/447; 428/689

(57) ABSTRACT

A process for the production of a layer system that is non-fogging and scratch resistant is disclosed. The layer system includes a substrate (S), one or more scratch-resistant layers (SR) and a non-fogging top layer (T). The process entails (a) applying one or more of at least partially cured coating composition to the substrate (S), the composition comprising a sol-gel produced polycondensate based on silane, to form a scratch-resistant layers (SR) and (b) subjecting the surface of the exposed scratch-resistant layer (SR) to flaming with simultaneous deposition of a layer which substantially comprises a compound of silicon, aluminium, titanium, indium, zirconium, tin and/or cerium to produce a non-fogging top layer (T).

### FIELD OF THE INVENTION

The present invention relates to a multi-layered laminate and to a process for its production.

### SUMMARY OF THE INVENTION

A process for the production of a layer system that is non-fogging and scratch resistant is disclosed. The layer system includes a substrate (S), one or more scratch-resistant layers (SR) and a non-fogging top layer (T). The process entails (a) applying one or more of at least partially cured coating composition to the substrate (S), the composition comprising a sol-gel produced polycondensate based on silane, to form a scratch-resistant layers (SR) and (b) subjecting the surface of the exposed scratch-resistant layer (SR) to flaming with simultaneous deposition of a layer which substantially comprises a compound of silicon, aluminium, titanium, indium, zirconium, tin and/or cerium to produce a non-fogging top layer (T).

### BACKGROUND OF THE INVENTION

With the aid of the sol-gel process, it is possible to produce inorganic-organic hybrid materials by controlled hydrolysis and condensation of alkoxides, predominantly of silicon, aluminium, titanium and zirconium.

An inorganic network is built up by this process. Organic groups, which can be used on the one hand for functionalization and on the other hand for formation of defined organic polymer systems, can additionally be incorporated via appropriately derivatized silicates. Because of the large number of possible combinations both of the organic and of the inorganic components and because of the great capacity for influencing the product properties by the production process, this material system offers a very wide range of variation. In particular, coating systems can be obtained and tailor-made to the most diverse profiles of requirements with this system.

Such coating systems are preferably used to provide plastics and glass with a scratch-resistant finish. Such coating compositions are described in more detail in the section “Preparation of the scratch-resistant layers”.

All these coatings are not non-fogging. In the context of the invention, non-fogging is understood as meaning that in water vapor at 90° C., the coated shaped articles do not become cloudy due to condensing moisture in the course of 10 min.

Furthermore, water drops applied thereto must wet the shaped article, the water contact angle being less than 40 degrees, preferably less than 20 degrees.

DE 199 52 040 A1 discloses substrates with a particularly abrasion-resistant diffusion barrier layer system, the diffusion barrier layer system comprising a hard base layer based on hydrolyzable epoxysilanes and a top layer arranged over this. The top layer is obtained by application and curing of a coating sol based on tetraethoxysilane.

U.S. Pat. No. 4,842,941 discloses a plasma coating process in which a siloxane lacquer is applied to a substrate, the substrate coated in this way is introduced into a vacuum chamber and the surface of the coated substrate is activated with oxygen plasma in vacuo. After the activation, dry-chemical or physical overcoating with a silane is carried out by CVD (chemical vapor deposition) under a high vacuum. A highly scratch-resistant layer of silicon oxide is formed on the substrate by this means.

Although in both cases the upper top layers substantially comprise silicon oxide, they are not non-fogging.

It is known from the prior art to provide shaped articles of plastics with a non-fogging finish by coating with coating compositions based on silica sols such as are described in EP-A 149 182, EP-A 378 855, EP-A 374 516, JP-A 51-6193, JP-A 51-81877, U.S. Pat. No. 4,994,318, JP-A 07 053747, JP-A 03 050288, JP-A 60-245685, JP-A 60-096682 and JP-A 58-029832, or based on organic hydrophilic polymers mentioned in EP-A 0 111 8646, DE-A 0 312 9262 and JP-A 200 3-01 2966.

U.S. Pat. No. 5,008,148 describes the coating of polycarbonate or polyphenylene sulfide articles with metal oxide layers by a low pressure plasma process for UV protection. The articles produced according to U.S. Pat. No. 5,008,148 are not non-fogging.

The components provided with a finish in this way are indeed non-fogging, but are limited in their scratch resistance and in the life of the anti-fogging properties under extreme conditions, such as boiling water in the form of steam or aggressive chemicals.

### DETAILED DESCRIPTION OF THE INVENTION

The present invention is therefore based on the object of providing a process for the production of a non-fogging scratch-resistant layer system (laminate) comprising a substrate (S), one or more scratch-resistant layers (SR) and a non-fogging top layer (T) which ensures optimum adhesion properties between the scratch-resistant layer (SR) and top layer (T) and is also suitable for uniform coating of three-dimensional substrates (S). The process should furthermore render possible decoupling of the preparation of the scratch-resistant layer (SR) and top layer (T) and ensure that once the scratch-resistant layer (SR) has been prepared, it can also still be coated without problems and readily with the top layer (T) after a storage period of some weeks or months.

This object is achieved according to the invention by a process for the production of a layer system comprising a substrate (S), one or more scratch-resistant layers (SR) and a non-fogging top layer (T) comprising

(a) applying one or more coating compositions to a substrate (S), the coating composition comprising a polycondensate, that is a product of the sol-gel process and based on at least one silane, and is at least partial cured to form a scratch-resistant layers (SR);

(b) subjecting the surface of the exposed scratch-resistant layer (SR) to flaming with simultaneous deposition of a layer which substantially comprises an oxidic compound of silicon, aluminium, titanium, indium, zirconium, tin and/or cerium by addition of compounds of silicon, aluminium, titanium, zirconium, tin and/or cerium into the fuel gas/air mixture to produce a non-fogging top layer (T).

After the application of the scratch-resistant layer (SR), the layer systems may be stored intermediately and then, at any desired point in time, surface-treated according to step (b) and overcoated with the top layer (T). The production process according to the invention is easy and inexpensive to carry out.

According to a preferred embodiment of the invention, the surface treatment of the scratch-resistant layer (SR) is carried out with simultaneous preparation of the non-fogging top layer (T) in step (b) by flaming with the addition of compounds of silicon, aluminium, titanium, zirconium, tin and/or cerium into the fuel gas/air mixture.

The metering of the additives for the preparation of the non-fogging top layer (T) operates in accordance with the principles of metered admixing of an organic precursor or an aerosol into the stream of air. Metering is carried out by a process-controlled vaporization or by a spray mist. Suitable apparatuses are, inter alia, the burner SMB22 in combination with the control apparatuses of the FTS series of Arcogas GmbH Rötweg 24 in Mönsheim, Germany. Readily vaporizable organometallic compounds, in particular alcoholates or acetates of the above metals, are suitable organic precursors. Silicon tetra-alkoxides have proved to be particularly favorable.

Aqueous dispersions of metal oxide nanoparticles, which are injected into the stream of air and precipitated, are most suitable for the preparation of aerosols.

Compared with the plasma process described in U.S. Pat. No. 5,008,148, application of the metal oxide layers in accordance with the present invention is considerably easier and less expensive.

During flaming, an open flame, preferably the oxidizing part thereof, acts on the surface of the scratch resistant layer. An action time of approx. 0.2 s is as a rule sufficient, depending on the shape and weight of the mold layer.

Experience shows that a mixture adjustment with an air content slightly above the stoichiometric mixture (slightly lean mixture) is preferred. For the oxidizing action of the flame, both the oxygen brought in from the outside during the combustion process and mostly the oxygen contained in the air/gas mixture fed in are of importance.

The air/gas mixture fed in also has a marked influence on the characteristics of the flame, and a flame operated with a “fat” mixture (high gas content) is thus just as unstable as one with a “lean” mixture (low gas content).

Standard predetermined values for the mixture adjustment are the following air/gas ratios:

| | | |
|---|---|---|
| Air to methane (natural gas) | ≧ | 8:1 |
| Air to propane (LPG) | ≧ | 25:1 |
| Air to butane | ≧ | 32:1 |

In addition to the mixture adjustment, the burner adjustment and burner distance are decisive for an effective flaming. The burner output influences the overall characteristics of the flame (temperature, ion distribution, size of the active zone). With a change in the burner output, the flame length changes, and the distance from the burner to the product in turn is determined by this.

The burner output, usually expressed in kW, is directly proportional to the amount of gas actually flowing (liters per minute). Too low an output leads to a improper treatment, i.e. the surface energy is not increased sufficiently. At a higher output a higher ion concentration is also established, and the treatment is intensified. Too high an output leads to a high material temperature and therefore to melting of the surface. This can be seen by the fact that the surfaces shine or are matt after the flaming.

The operating speed and therefore the possible contact time are usually predetermined by the user, and the burner output requirement is determined by this means. The operating speed and the burner output should always be coordinated with one another to the optimum in the context of experiments.

It has proved to be particularly advantageous if the flaming is carried out in a flow-through flaming installation at a flow-through speed of 1 to 20 m/min, in particular 2 to 10 m/min.

The adhesion energy of the scratch-resistant layer (SR) is increased by the surface treatment, as a result of which a very good adhesion of the non-fogging top layer (T) is achieved. The non-fogging top layer (T) has a water contact angle of less than 40 degrees, preferably less than 20 degrees, and the polar content of the surface tension of the top layer (T) is above 20%, preferably above 30%.

It is furthermore advantageous if the surface treatment is carried out after complete curing of the scratch-resistant layer (SR).

Preparation of the Scratch-Resistant Layer (Sr)

The scratch-resistant layer (SR) is prepared in step (a) by the application of a coating composition to a substrate (S), the coating composition comprising a polycondensate which is based on at least one silane and prepared by the sol-gel process, and at least partially cured. The preparation of such scratch-resistant layers (SR) on a substrate (S) is known in principle to the expert.

The choice of substrate materials (S) is not limited. The se include wood, textiles, paper, stoneware, metals, glass, ceramic and plastics, and in particular thermoplastics, such as are described in Becker/Braun, Kunststofftaschenbuch, Carl Hanser Verlag, Munich, Vienna 1992. Particularly suitable are transparent thermoplastics, preferably polycarbonates. In particular, spectacle lenses, optical lenses, automobile windscreens and sheets are suitable according to the invention.

The scratch-resistant layer (SR) is preferably formed in a thickness of 0.5 to 30 μm. A primer layer (P) may be formed between the substrate (S) and scratch-resistant layer (SR).

Any desired silane-based polycondensates prepared by the sol-gel process are suitable as coating compositions for the scratch-resistant layer (SR). Particularly suitable are, in particular,

(1) methylsilane systems,

(2) silica sol-modified methylsilane systems,

(3) silica sol-modified silyl acrylate systems,

(4) silyl acrylate systems (in particular boehmite) modified with other nanoparticles,

(5) cyclic organosiloxane systems and

(6) epoxysilane systems modified with nanoparticles.

The abovementioned coating compositions for the scratch-resistant layer (SR) are described in more detail in the following:

(1) Methylsilane Systems

Known polycondensates based on methylsilane may be employed, for example, as coating compositions for the scratch-resistant layer (SR). Polycondensates based on methyltrialkoxysilanes are preferably employed. The substrate (S) may be coated, for example, by applying a mixture of at least one methyltrialkoxysilane, water-containing organic solvent and an acid, evaporating the solvent and curing the silane under the influence of heat, resulting in the formation of a highly crosslinked polysiloxane. The mixture of the methyltrialkoxysilane preferably comprises the silane to the extent of 60 to 80 wt. %. Methyltrialkoxysilanes which hydrolyzes rapidly, which is the case in particular if the alkoxy group contains not more than four carbon atoms, are particularly suitable. Suitable catalysts for the condensation reaction of the silanol groups formed by hydrolysis of the alkoxy groups of the methyltrialkoxysilane are, in particular, strong inorganic acids, such as sulfuric acid and perchloric acid. The concentration of the acid catalyst is preferably about 0.15 wt. %, based on the silane. Suitable inorganic solvents for the system comprising methyltrialkoxysilane, water and acid are alcohols, such as methanol, ethanol and isopropanol, or ether alcohols, such as ethyl glycol. The mixture preferably comprises 0.5 to 1 mol of water per mol of silane. The preparation, application and curing of such coating compositions are known to the expert and are described, for example, in the publications DE-A 2136001, DE-A 2113734 and U.S. Pat. No. 3,707,397 incorporated herein by reference.

(2) Silica Sol-Modified Methylsilane Systems

Polycondensates based on methylsilane and silica sol may be employed as coating compositions for the scratch-resistant layer (SR). Particularly suitable coating compositions of this type are polycondensates, prepared by the sol-gel process, of substantially 10 to 70 wt. % silica sol and 30 to 90 wt. % of a partly condensed organoalkoxysilane in an aqueous/organic solvent mixture. Particularly suitable coating compositions are the thermosetting, primer-free silicone hardcoat compositions described in U.S. Pat. No. 5,503,935 (incorporated herein by reference) which comprise, based on the weight:

(A) 100 parts of resin solids in the form of a silicone dispersion in an aqueous/organic solvent with 10 to 50 wt. % solids and substantially comprising 10 to 70 wt. % colloidal silicon dioxide and 30 to 90 wt. % of a partial condensate of an organoalkoxysilane and

(B) 1 to 15 parts of an adhesion promoter selected from

(i) an acrylated polyurethane adhesion promoter with an M n of 400 to 1,500 and selected from among acrylated polyurethane and a methacrylated polyurethane and

(ii) an acrylic polymer with reactive or interactive sites and an M n of at least 1,000.

Organoalkoxysilanes which may be employed in the preparation of the dispersion of the thermosetting, primer-free silicone hardcoat compositions in an aqueous/organic solvent preferably conform to the formula

(R)ₐSi(OR¹)₄₋ₐ

wherein R is a monovalent C₁₋₆-hydrocarbon radical, in particular a C₁₋₄-alkyl radical, R¹ is R or hydrogen and a is an integer from 0 to and including 2. The organoalkoxysilane of the abovementioned formula is preferably methyltrimethoxysilane, methyltrihydroxysilane or a mixture thereof which may form a partial condensate.

The preparation, properties and curing of such thermosetting, primer-free silicone hardcoat compositions are known to the expert and are described in detail, for example, in the publication U.S. Pat. No. 5,503,935.

Polycondensates based on methylsilanes and silica sol with a solids content of 10 to 50 wt. % dispersed in a water/alcohol mixture may be employed as coating compositions for the scratch-resistant layer (SR). The solids dispersed in the mixture comprise silica sol, in particular in an amount of 10 to 70 wt. %, and a partial condensate derived from organotrialkoxysilanes, preferably in an amount of 30 to 90 wt. %, the partial condensate preferably having the formula R′Si(OR)₃, wherein R¹ is selected from the group consisting of alkyl radicals having 1 to 3 carbon atoms and aryl radicals having 6 to 13 carbon atoms and R is selected from the group consisting of alkyl radicals having 1 to 8 carbon atoms and aryl radicals having 6 to 20 carbon atoms. The coating composition preferably has an alkaline pH, in particular a pH of 7.1 to about 7.8, which is achieved by a base which is volatile at the curing temperature of the coating composition. The preparation, properties and curing of such coating compositions are known to the expert and are described, for example, in the publication U.S. Pat. No. 4,624,870, the content of which is expressly incorporated herein by reference.

The abovementioned coating compositions described in U.S. Pat. No. 4,624,870 are usually employed in combination with a suitable primer, the primer forming an intermediate layer between the substrate (S) and scratch-resistant layer (SR). Suitable primer compositions are, for example, polyacrylate primers. Suitable polyacrylate primers are those based on polyacrylic acid, polyacrylic esters and copolymers of monomers with the general formula

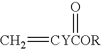

wherein Y represents H, methyl or ethyl and R denotes a C₁₋₁₂-alkyl group. The polyacrylate resin may be thermoplastic or thermosetting and is preferably dissolved in a solvent. A solution of polymethyl methacrylate (PMMA) in a solvent mixture of a rapidly evaporating solvent, such as propylene glycol methyl ether, and a solvent which evaporates more slowly, such as diacetone alcohol, may be employed, for example, as the acrylate resin solution. Particularly suitable acrylate primer solutions are thermoplastic primer compositions comprising

(A) polyacrylic resin and

(B) 90 to 99 parts by weight of an organic solvent mixture comprising

(i) 5 to 25 wt. % of a solvent with a boiling point of 150 to 200° C. under atmosphere pressure, in which (A) is freely soluble, and

(ii) 75 to 95 wt. % of a less potent solvent with a boiling point of 90 to 150° C. under normal conditions, in which (A) is soluble.

The preparation, properties and drying of the thermoplastic primer compositions mentioned above are known to the expert and are described in detail, for example, in U.S. Pat. No. 5,041,313, the content of which is expressly incorporated herein by reference. As already mentioned above, the primer layer is arranged between the substrate (S) and scratch-resistant layer (SR) and serves to promote adhesion between the two layers.

Further coating compositions for the scratch-resistant layer (SR) based on methylsilane and silica sol are described, for example, in the publications EP 0 570 165 A2, U.S. Pat. No. 4,278,804, U.S. Pat. No. 4,495,360, U.S. Pat. No. 4,624,870, U.S. Pat. No. 4,419,405, U.S. Pat. No. 4,374,674 and U.S. Pat. No. 4,525,426, all incorporated herein by reference.

(3) Silica Sol-Modified Silyl Acrylate Systems

Polycondensates based on silyl acrylate may be employed as coating compositions for the scratch-resistant layer (SR). In addition to silyl acrylate, these coating compositions preferably comprise colloidal silica earth (silica sol). Possible silyl acrylates are, in particular, acryloxy-functional silanes of the general formula

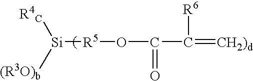

in which R³ and R⁴ are identical or different monovalent hydrocarbon radicals, R⁵ is a divalent hydrocarbon radical having 2 to 8 carbon atoms, R denotes hydrogen or a monovalent hydrocarbon radical, the index b is an integer having a value from 1 to 3, the index c is an integer having a value of 0 to 2 and the index d is an integer having a value of (4-b-c), or

glycidoxy-functional silanes of the general formula

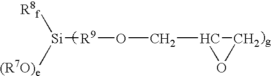

wherein R⁷ and R⁸ are identical or different monovalent hydrocarbon radicals, R⁹ denotes a divalent hydrocarbon radical having 2 to 8 carbon atoms, the index e is an integer having a value of 1 to 3, the index f is an integer having a value of 0 to 2 and the index g is an integer having a value of (4-e-f), and mixtures thereof. The preparation and properties of these acryloxy-functional silanes and glycidoxy-functional silanes are known in principle to the expert and are described, for example, in DE 31 26 662 A1 (WO8200295) incorporated herein by reference. Particularly suitable acryloxy-functional silanes are, for example, 3-methacryloxypropyltrimethoxysilane, 3-acryloxypropyltrimethoxysilane, 2-methacryloxyethyltrimethoxysilane, 2-acryloxyethyltrimethoxysilane, 3-methacryloxypropyltriethoxysilane, 3-acryloxypropyltriethoxysilane, 2-methacryloxyethyltriethoxysilane and 2-acryloxyethyltriethoxysilane. Particularly suitable glycidoxy-functional silanes are, for example, 3-glycidoxypropyltrimethoxysilane, 2-glycidoxyethyltrimethoxysilane, 3-glycidoxypropyltriethoxysilane and 2-glycidoxyethyltriethoxysilane. These compounds are also described in DE 31 26 662 A1. These coating compositions can comprise further acrylate compounds, in particular hydroxyacrylates, as a further constituent. Further acrylate compounds which can be employed are, for example, 2-hydroxyethyl acrylate, 2-hydroxyethyl methacrylate, 3-hydroxypropyl acrylate, 3-hydroxypropyl methacrylate, 2-hydroxy-3-methacryloxypropyl acrylate, 2-hydroxy-3-acryloxypropyl acrylate, 2-hydroxy-3-methacryloxypropyl methacrylate, diethylene glycol diacrylate, triethylene glycol diacrylate, tetraethylene glycol diacrylate, trimethylolpropane triacrylate, tetrahydrofurfuryl methacrylate and 1,6-hexanediol diacrylate. Particularly preferred coating compositions of this type are those which comprise 100 parts by weight of colloidal silica earth, 5 to 500 parts by weight of silyl acrylate and 10 to 500 parts by weight of further acrylate. In combination with a catalytic amount of a photoinitiator, after application to a substrate (S) such coating compositions may be cured by UV radiation with the formation of a scratch-resistant layer (SR), as described in DE 31 26 662 A1. The coating compositions may comprise conventional additives. The scratch-resistant coatings described in U.S. Pat. No. 5,990,188 (incorporated herein by reference) which may be cured by irradiation and also comprise, in addition to the abovementioned constituents, a UV absorber, such as triazine or dibenzylresorcinol derivatives, are furthermore particularly suitable. Further coating compositions based on silyl acrylates and silica sol are described in the publications U.S. Pat. No. 5,468,789, U.S. Pat. No. 5,466,491, U.S. Pat. No. 5,318,850, U.S. Pat. No. 5,242,719 and U.S. Pat. No. 4,455,205, all incorporated herein by reference.

(4) Silyl Acrylate Systems Modified with Nanoparticles

Polycondensates based on silyl acrylates and which contain nanoscale AlO(OH) particles, in particular nanoscale boehmite particles, as a further constituent may be employed as coating compositions. Such coating compositions are described, for example, in the publications WO 98/51747 A1, WO 00/14149 A1, DE-A 197 46 885, U.S. Pat. No. 5,716,697 and WO 98/04604 A1, all incorporated herein by reference. By addition of photoinitiators, after application to a substrate (S) these coating compositions may be cured by UV radiation with the formation of a scratch-resistant layer (SR).

(5) Cyclic Organosiloxane Systems

Polycondensates based on multifunctional cyclic organosiloxanes may be employed as coating compositions for the scratch-resistant layer (SR). Possible such multifunctional, cyclic organosiloxanes are, in particular, those of the following formula

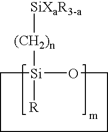

where m=3 to 6, preferably 3 to 4, n=2 to 10, preferably 2 to 5, particularly preferably 2, R═C₁ to C₈-alkyl and/or C₆ to C₁₄-aryl, preferably C₁ to C₂-alkyl, wherein n and R within the molecule can be identical or non-identical, preferably identical, and wherein the further radicals have the following meaning:

(A) for X=halogen, i.e. Cl, Br, I and F, preferably Cl, with a=1 to 3 or X═OR′, OH with a=1 to 2, with R′=C₁ to C₈-alkyl preferably C₁ to C₂-alkyl, or

(B) for X═(OSiR₂)ₚ[(CH₂)ₙSiYₐR₃₋ₐ] with a=1 to 3, wherein a within the molecule can be identical or non-identical, preferably identical,

p=0 to 10, preferably p=0, and

Y=halogen, OR′, OH, preferably Cl, OR′, OH with R′=C₁ to C₈-alkyl, preferably C₁ to C₂-alkyl, or

(C) X═(OSiR₂)ₚ[(CH₂)ₙSiR₃₋ₐ[CH₂)ₙSiYₐR₃₋ₐ]a] with a=1 to 3, wherein a within the molecule can be identical or non-identical, preferably identical,

p=0 to 10, preferably p=0, and

Y=halogen, OR′, OH, preferably Cl, OR′, OH with R′=C₁ to C₈-alkyl, preferably C₁ to C₂-alkyl.

Compounds with n=2, m=4, R=methyl and X═OH, OR′ with R′=methyl, ethyl and a=1 are particularly suitable. The preparation and properties of such multifunctional cyclic organosiloxanes and their use in scratch-resistant coating compositions are known in principle to the expert and are described, for example, in the publication DE 196 03 241 C1, the content of which is incorporated herein by reference. Further coating compositions based on cyclic organosiloxanes are described, for example, in the publications WO 98/52992, DE 197 11 650, WO 98/25274 and WO 98/38251, the content of which is incorporated herein by reference.

(6) Epoxysilane Systems Modified with Nanoparticles

Polycondensates based on hydrolysable silanes with epoxide groups are also suitable as coating compositions for the scratch-resistant layer (SR). Preferred scratch-resistant layers (SR) are obtained by curing of a coating composition comprising a polycondensate, prepared by the sol-gel process, based on at least one silane which has an epoxide group on a non-hydrolyzable substituent and optionally a curing catalyst chosen from Lewis bases and alcoholates of titanium, zirconium or aluminium. The preparation and properties of such scratch-resistant layers (SR) are described, for example, in DE 43 38 361 A1.

Preferred coating compositions for scratch-resistant layers based on epoxysilanes and nanoparticles are those which comprise

a silicon compound (A) with at least one radical which cannot be split off by hydrolysis, is bonded directly to Si and contains an epoxide group,

particulate materials (B),

a hydrolyzable compound (C) of Si, Ti, Zr, B, Sn or V and, preferably, additionally

a hydrolyzable compound (D) of Ti, Zr or Al.

Such coating compositions result in highly scratch-resistant coatings which adhere particularly well to the substrate material.

The compounds (A) to (D) are explained in more detail in the following. The compounds (A) to (D) may be contained not only in the composition for the scratch-resistant layer (SR) but also as (an) additional component(s) in the composition for the top layer (T).

Silicon Compound (A)

The silicon compound (A) is a silicon compound which has 2 or 3, preferably 3 hydrolyzable radicals and one or 2, preferably one non-hydrolyzable radical. The only or at least one of the two non-hydrolyzable radicals has an epoxide group.

Examples of the hydrolyzable radicals are halogen (F, Cl, Br and I, in particular Cl and Br), alkoxy (in particular C₁₋₄-alkoxy, such as e.g. methoxy, ethoxy, n-propoxy, i-propoxy and n-butoxy, i-butoxy, sec-butoxy and tert-butoxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl). Particularly preferred hydrolyzable radicals are alkoxy groups, in particular methoxy and ethoxy.

Examples of non-hydrolyzable radicals without an epoxide group are hydrogen, alkyl, in particular C₁₋₄-alkyl (such as e.g. methyl, ethyl, propyl and butyl), alkenyl (in particular C₂₋₄-alkenyl, such as e.g. vinyl, 1-propenyl, 2-propenyl and butenyl), alkinyl (in particular C₂₋₄-alkinyl, such as e.g. acetylenyl and propargyl) and aryl, in particular C₆₋₁₀-aryl (such as e.g. phenyl and naphthyl), it being possible for the groups just mentioned optionally to have one or more substituents, such as e.g. halogen and alkoxy. Methacryl- and methacryloxypropyl radicals may also be mentioned in this connection.

Examples of non-hydrolyzable radicals with an epoxide group are, in particular, those which have a glycidyl or glycidyloxy group.

Examples of silicon compounds (A) which may be employed according to the invention are disclosed e.g. on pages 8 and 9 of EP-A-195 493 (U.S. Pat. No. 4,895,767, incorporated herein by reference).

Silicon compounds (A) which are particularly preferred according to the invention are those of the general formula

R₃Si′

in which the radicals R are identical or different (preferably identical) and represent a hydrolyzable group (preferably C₁₋₄-alkoxy, and in particular methoxy and ethoxy) and R′ represents a glycidyl- or glycidyloxy-(C₁₋₂₀)-alkylene radical, in particular β-glycidyloxyethyl-, γ-glycidyloxypropyl-, δ-glycidyloxybutyl-, ε-glycidyloxylpentyl-, ω-glycidyloxyhexyl-, ω-glycidyloxyoctyl-, ω-glycidyloxynonyl-, ω-glycidyloxydecyl-, ω-glycidyloxydodecyl- and 2-(3,4-epoxy-cyclohexyl)-ethyl.

γ-Glycidyloxypropyltrimethoxysilane (abbreviated to GPTS in the following) is particularly preferably employed according to the invention because of its easy availability.

Particulate Materials (B)

The particulate materials (B) are any of oxide, hydrated oxide, nitride or carbide of Si, Al and B and of transition metals, preferably Ti, Zr and Ce, with a particle size in the range from 1 to 100, preferably 2 to 50 nm and particularly preferably 5 to 20 nm, and mixtures thereof. These materials may be employed in the form of a powder, but are preferably used in the form of a sol (in particular acid-stabilized sol). Preferred particulate materials are boehmite, SiO₂, CeO₂, ZnO, In₂O₃ and TiO₂. Nanoscale boehmite particles are particularly preferred. The particulate materials are commercially available in the form of powders and the preparation of (acid-stabilized) sols therefrom is also known in the prior art. In this context, reference may moreover be made to the preparation examples given below. The principle of stabilization of nanoscale titanium nitride by means of guanidinepropionic acid is described e.g. in the German patent application DE-A 43 34 639.

Boehmite sol with a pH in the range from 2.5 to 3.5, preferably 2.8 to 3.2, which may be obtained, for example, by suspending boehmite powder in dilute HCl, is particularly preferably employed.

The variation in the nanoscale particles as a rule is accompanied by a variation in the refractive index of the corresponding materials. Thus e.g. the replacement of boehmite particles by CeO₂, ZrO₂ or TiO₂ particles leads to materials with higher refractive indices, the refractive index resulting additively from thee volume of the highly refracting component and the matrix in accordance with the Lorentz-Lorenz equation.

As mentioned, cerium dioxide may be employed as the particulate material. This preferably has a particle size in the range from 1 to 100, preferably 2 to 50 nm and particularly preferably 5 to 20 nm. This material may be employed in the form of a powder, but is preferably used in the form of a sol (in particular acid-stabilized sol). Particulate cerium oxide is commercially obtainable in the form of sols and of powders and the preparation of (acid-stabilized) sols therefrom is also known in the prior art.

Compound (B) is preferably employed in the composition for the scratch-resistant layer (SR) in an amount of 3 to 60 wt. %, based on the solids content of the coating composition for the scratch-resistant layer (SR).

Hydrolyzable Compounds (C)

In addition to the silicon compounds (A), other hydrolyzable compounds of elements from the group consisting of Si, Ti, Zr, Al, B, Sn and V are also used for the preparation of the scratch-resistant layer coating composition and are preferably hydrolyzed with the silicon compound(s) (A).

Compound (C) is a compound of Si, Ti, Zr, B, Sn and V of the general formula

RₓXM⁺⁴R′₄₋ₓ or

RₓM⁺³R′₃₋ₓ

wherein M represents a) Si⁺⁴, Ti⁺⁴, Zr⁺⁴, Sn⁺⁴, or b) Al⁺³, B⁺³ or (Vo)⁺³, R represents a hydrolyzable radical, R′ represents a non-hydrolyzable radical and x may be 1 to 4 in the case of tetravalent metal atoms M (case a)) and 1 to 3 in the case of trivalent metal atoms M (case b)). If several radicals R and/or R′ are present in a compound (C), these may in each case be identical or different. Preferably, x is greater than 1, i.e. the compound (C) has at least one, preferably several hydrolyzable radicals.

Examples of the hydrolyzable radicals are halogen (F, Cl, Br and I, in particular Cl and Br), alkoxy (in particular C₁₋₄-alkoxy, such as e.g. methoxy, ethoxy, n-propoxy, i-propoxy and n-butoxy, i-butoxy, sec-butoxy or tert-butoxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl). Particularly preferred hydrolyzable radicals are alkoxy groups, in particular methoxy and ethoxy.

Examples of non-hydrolyzable radicals are hydrogen, alkyl, in particular C₁₋₄-alkyl (such as e.g. methyl, ethyl, propyl and n-butyl, i-butyl, sec-butyl and tert-butyl),

alkenyl (in particular C₂₋₄-alkenyl, such as e.g. vinyl, 1-propenyl, 2-propenyl and butenyl), alkinyl (in particular C₂₋₄-alkinyl, such as e.g. acetylenyl and propargyl) and

aryl (in particular C₆₋₁₀-aryl, such as e.g. phenyl and naphthyl), it being possible for the groups just mentioned optionally to have one or more substituents, such as e.g. halogen and alkoxy. Methacryl- and methacryloxypropyl radicals may also be mentioned in this connection.

In addition to the as examples of the compounds of the formula I contained in the top layer composition, the following preferred examples of compound (C) may be mentioned:

CH₃—SiCl₃, CH₃—Si(OC₂H)₅)₃, C₂H₅—SiCl₃, C₂H₅—Si(OC₂H₅)₃,

C₃H₇—Si(OCH₃)₃, C₆H₅—Si(OCH₃)₃, C₆H₅—Si(OC₂H₅)₃,

(CH₂O)₃—Si—C₃H₆—CI,

(CH₃)₂SiCl₂, (CH₃)₂Si(OCH₃)₂, (CH₃)₂Si(OC₂H₅)₂,

(CH₃)₂Si(OH)₂, (C₆H₅)₂SiCl₂, (C₆H₅)₂Si(OCH₃)₂,

(C₆H₅)₂Si(OC₂H₅)₂, (i-C₃H₇)₃SiOH,

CH₂═CH—Si(OOCCH₃)₃,

CH₂═CH—SiCl₃, CH₂═CH—Si(OCH₃)₃, CH₂═CH—Si(OC₂H₅)₃,

CH₂═CH—Si(OC₂H₄OCH₃)₃, CH₂═CH—CH₂—Si(OCH₃)₃,

CH₂═CH—CH₂—Si(OC₂H₅)₃,

CH₂═CH—CH₂—Si(OOCCH₃)₃,

CH₂═C(CH₃)—COO—C₃H₇—Si(OCH₃)₃,

CH₂═C(CH₃)—COO—C₃H₇—Si(OC₂H₅)₃.

Compounds of the type SiR₄, wherein the radicals R may be identical or different and represent a hydrolyzable group, preferably an alkoxy group having 1 to 4 carbon atoms, in particular methoxy, ethoxy, n-propoxy, i-propoxy, n-butoxy, i-butoxy, sec-butoxy or tert-butoxy, are particularly preferably employed.

As may be seen, these compounds (C) (in particular the silicon compounds) may also have non-hydrolyzable radicals which contain a C—C double or triple bond. If such compounds are employed together with (or even instead of) the silicon compounds (A), monomers (preferably containing epoxide or hydroxyl groups), such as e.g. meth(acrylates), may also additionally be incorporated into the composition (these monomers may of course also have two or more functional groups of the same type, such as e.g. poly(meth)acrylates of organic polyols; the use of organic polyepoxides is also possible). During thermal or photochemically induced curing of the corresponding composition, in addition to the build-up of the organically modified inorganic matrix a polymerization of the organic species then takes place, as a result of which the crosslinking density and therefore also the hardness of the corresponding coatings and shaped articles increase.

Compound (C) is preferably employed in the composition for the scratch-resistant layer (SR) in an amount of 0.2 to 1.2 mol per mol of silicon compound (A).

Hydrolyzable Compound (D)

The hydrolyzable compound (D) is a compound of Ti, Zr or Al of the following general formula

M(R′″)ₘ

wherein M represents Ti, Zr or Al and the radicals R′″ may be identical or different and represent a hydrolyzable group and n is 4 (M=Ti, Zr) or 3 (M=Al).

Examples of the hydrolyzable groups are halogen (F, Cl, Br and I, in particular Cl and Br), alkoxy (in particular C₁₋₆-alkoxy, such as e.g. methoxy, ethoxy, n-propoxy, i-propoxy and n-butoxy, i-butoxy, sec-butoxy or tert-butoxy, n-pentyloxy, n-hexyloxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl), or a C₁₋₆-alkoxy-C₂₋₃-alkyl group, i.e. a group derived from C₁₋₆-alkylethylene glycol or -propylene glycol, wherein alkoxy has the same meaning as mentioned above.

Particularly preferably, M is aluminium and R′″ is ethanolate, sec-butanolate, n-propanolate or n-butoxyethanolate.

Compound (D) is preferably used in the composition for the scratch-resistant layer (SR) in an amount of 0.23 to 0.68 mol per mol of silicon compound (A).

To achieve a more hydrophilic character of the scratch-resistant layer coating composition, a Lewis base (E) may optionally additionally be used as a catalyst.

A hydrolyzable silicon compound (F) which has at least one non-hydrolyzable radical and has 5 to 30 fluorine atoms bonded directly to carbon atoms, these carbon atoms being separated by at least 2 atoms of Si, may furthermore optionally additionally be employed. The use of such a fluorinated silane leads to hydrophobic and dirt-repellent properties additionally being imparted to the corresponding coating.

The preparation of the compositions for the scratch-resistant layer (SR) may be carried out by the process described in more detail below, in which a sol of the material (B) with a pH in the range from 2.0 to 6.5, preferably 2.5 to 4.0, is reacted with a mixture of the other components.

They are even more preferably prepared by a process which is also defined below, in which the sol as defined above is added in two part portions to the mixture of (A) and (C), particular temperatures preferably being maintained and the addition of (D) taking place between the two portions of (B), also preferably at a particular temperature.

The hydrolyzable silicon compound (A) may optionally be prehydrolyzed together with the compound (C) using an acid catalyst (preferably at room temperature) in aqueous solution, about ½ mol of water preferably being employed per mol of hydrolyzable group. Hydrochloric acid is preferably employed as the catalyst for the prehydrolysis.

The particulate materials (B) are preferably suspended in water and the pH is adjusted to 2.0 to 6.5, preferably to 2.5 to 4.0. Hydrochloric acid is preferably used for the acidification. If boehmite is used as the particulate material (B), a clear sol forms under these conditions.

The compound (C) is mixed with the compound (A). The first part portion of the particulate material (B) suspended as described above is then added. The amount is preferably selected such that the water contained therein is sufficient for semi-stoichiometric hydrolysis of the compounds (A) and (C). It is 10 to 70 wt. % of the total amount, preferably 20 to 50 wt. %.

The reaction proceeds slightly exothermically. After the first exothermic reaction has subsided, the temperature is adjusted to approx. 28 to 35° C., preferably approx. 30 to 32° C., by heating, until the reaction starts and an internal temperature which is higher than 25° C., preferably higher than 30° C. and even more preferably higher than 35° C. is reached. When the addition of the first portion of the material (B) has ended, the temperature is maintained for a further 0.5 to 3 hours, preferably 1.5 to 2.5 hours, and the mixture is then cooled to approx. 0° C. The remaining material (B) is preferably added slowly at a temperature of 0° C. Thereafter, the compound (D) and optionally the Lewis base (E) are added slowly at approx. 0° C., also preferably after the addition of the first part portion of the material (B). The temperature is then kept at approx. 0° C. for 0.5 to 3 hours, preferably for 1.5 to 2.5 hours, before addition of the second portion of the material (B). Thereafter, the remaining material (B) is added slowly at a temperature of approx. 0° C. The solution added dropwise is preferably cooled to approx. 10° C. directly before the introduction to the reactor.

After the slow addition of the second part portion of the compound (B) at approx. 0° C., the cooling is preferably removed, so that warming up of the reaction mixture to a temperature of more than 15° C. (to room temperature) takes place slowly without additional heating.

Inert solvents or solvent mixtures may optionally be added at any desired stage of the preparation to adjust the rheological properties of the scratch-resistant layer compositions. These solvents are preferably the solvents described for the top layer composition.

The scratch-resistant layer compositions may comprise the conventional additives described for the top layer composition.

The application and curing of the scratch-resistant layer composition take place, after drying at ambient temperature, preferably thermally at 50 to 200° C., preferably 70 to 180° C. and in particular 110 to 130° C. The curing time under these conditions should be less than 120, preferably less than 90, in particular less than 60 minutes.

The layer thickness of the cured scratch-resistant layer (SR) should be 0.5 to 30 μm, preferably 1 to 20 μm and in particular 2 to 10 μm.

Preparation of a further highly scratch-resistant layer (SSR) as an intermediate layer between the scratch-resistant layer (SR) and the non-fogging top layer (T)

If desired, a highly scratch-resistant layer (SSR) is prepared by application of a solvent-containing coating composition based on a silane to the surface-treated scratch-resistant layer (SR) and curing thereof.

The coating compositions for the highly scratch-resistant layer (SSR) may be, for example, the coating sols, known from DE 199 52 040 A1, of tetraethoxysilane (TEOS) and glycidyloxypropyl-trimethoxysilane (GPTS). The coating sol is prepared by prehydrolyzing and condensing TEOS with ethanol as the solvent in HCl-acid aqueous solution. GPTS is then stirred into the TEOS prehydrolyzed in this manner and the sol is stirred for some time, while heating. Other variants are described in DE 102 45 729, DE 102 45 725 and DE 102 52 421.

### EXAMPLES

### Example 1

354.5 g (3.0 mol) n-butoxyethanol were added dropwise to 246.3 g (1.0 mol) aluminium tri-sec-butanolate, while stirring, during which the temperature rose to approx. 45° C. After cooling, the aluminate solution must be stored in a closed container.

1,239 g 0.1 N HCl were initially introduced into the vessel. 123.9 g (1.92 mol) boehmite (Disperal Sol P3® from Condea) were added, while stirring. Thereafter, the mixture was stirred at room temperature for 1 hour. To separate off solid impurities, the solution was filtered through a low-pass filter.

787.8 g (3.33 mol) GPTS (γ-glycidyloxypropyltrimethoxysilane) and 608.3 g TEOS (tetraethoxysilane) (2.92 mol) were mixed and the mixture was stirred for 10 minutes. 214.6 g of the boehmite sol were added to this mixture in the course of approx. 2 minutes. A few minutes after the addition, the sol heated up to approx. 28 to 30° C., and was also clear after approx. 20 minutes. The mixture was then stirred at 35° C. for approx. 2 hours and subsequently cooled to approx. 0° C.

600.8 g of the Al(OEtOBu)₃ solution in sec-butanol, prepared as described above, comprising 1.0 mol Al(OEtOBu)₃ were then added at 0° C.±2° C. When the addition had ended, the mixture was stirred at approx. 0° C. for a further 2 hours and the remaining boehmite sol was then added, also at 0° C. ±2° C. Warming up of the reaction mixture obtained to room temperature then took place in approx. 3 hours without heating. Byk® 306 from Byk was added as a flow agent. The mixture was filtered and the lacquer obtained was stored at +4° C.

### Example 2

GPTS and TEOS are initially introduced into the vessel and mixed. The amount of boehmite dispersion (prepared analogously to example 1) necessary for semi-stoichiometric prehydrolysis of the silanes is slowly poured in, while stirring. The reaction mixture is then stirred at room temperature for 2 hours. The solution is then cooled to 0° C. with the aid of a cryostat. Aluminium tributoxyethanolate is then added dropwise via a dropping funnel. After addition of the aluminate, the mixture is stirred at 0° C. for a further 1 hour. Thereafter, the remainder of the boehmite dispersion is added, while cooling with a cryostat. After stirring at room temperature for 15 minutes, the cerium dioxide dispersion and BYK® 306, as a flow agent, are added.

Batch Amounts

| | |
|---|---|
| TEOS | 62.50 g (0.3 mol) |
| GPTS | 263.34 g (1 mol) |
| Boehmite | 5.53 g |
| 0.1 N hydrochloric acid | 59.18 g |
| Cerium dioxide dispersion (20 wt. % in 2.5 wt. % | 257.14 g |
| acetic acid) | |
| Boehmite dispersion for semi-stoichiometric | 41.38 g |
| prehydrolysis | |
| Aluminium tributoxyethanolate | 113.57 g (0.3 mol) |

### Example 3

### Primer

The primer solution is prepared by dissolving 6 g Araldit PZ 3962 and 1.3 g Araldit PZ 3980 in 139.88 g diacetone alcohol at room temperature in accordance with the patent application EP-A 1282 673. (US2003194561 incorporated herein by reference)

### Example 4

203 g methyltrimethoxysilane were mixed with 1.25 g glacial acetic acid. 125.5 g Ludox® AS (ammonium-stabilized colloidal silica sol from DuPont, 40% SiO₂ with a silicate particle diameter of about 22 nm and a pH of 9.2) were diluted with 41.5 g deionized water in order to adjust the content of SiO₂ to 30 wt. %. This material was added to the acidified methyltrimethoxysilane, while stirring. The solution was stirred for a further 16 to 18 hours at room temperature and a solvent mixture of isopropanol/n-butanol in the weight ratio 1:1 was then added. Finally, 32 g of the UV absorber 4-[γ-(tri-(methoxy/ethoxy)silyl)propoxy]-2-hydroxybenzophenone were added. The mixture was stirred at room temperature for two weeks. The composition had a solids content of 20 wt. % and contained 11 wt. % of the UV absorber, based on the solid constituents. The coating composition had a viscosity of about 5 cSt at room temperature.

To accelerate the polycondensation reaction, 0.2 wt. % tetrabutylammonium acetate were mixed in homogeneously before the application.

### Example 5

### Primer

3.0 parts polymethyl methacrylate (Elvacite® 2041 from DuPont) were mixed with 15 parts diacetone alcohol and 85 parts propylene glycol monomethyl ether and the mixture was stirred at 70° C. for two hours until the components had dissolved completely. 0.5 part of the UV absorber Uvinol N 539 (cyanoacrylate) from BASF, Ludwigshafen were then also added to the solution.

### Example 6

0.4 wt. % of a silicone flow agent and 0.3 wt. % of an acrylate polymer, that is to say Joncryl 587 (Mₙ 4,300) from S.C. Johnson Wax Company in Racine, Wis., were stirred into the coating sol prepared according to example 4. To accelerate the polycondensation reaction, 0.2 wt. % tetra-n-butylammonium acetate were mixed in homogeneously, as in example 4, before the application.

Production of Test Specimens

Sheets of dimensions 100*150*3.2 mm were produced from polycarbonate (Makrolon 3103′ and Makrolon AL 2647® from Bayer AG) by an injection molding process on the injection molding machine FH160 from Klockner. The polycarbonate granules were dried to a residual moisture content of less than 0.01% at 120° C. for twelve hours in a circulating air drying cabinet before the processing. The melt temperature was 300° C. The mold was heated at 90° C. The closing pressure was 770 bar and the holding pressure was 700 bar. The total cycle time of the injection molding operation was 48.5 seconds.

Makrolon 3103 is a UV-stabilized bisphenol A polycarbonate with an average molecular weight M_{w} (weight-average) of approx. 31,000 g/mol. Makrolon AL 2647, also a bisphenol A polycarbonate, contains an additive package of UV stabilizer, mold release agent and heat stabilizer. Its average molecular weight M_{w} is approx. 26,500 g/mol.

Coating of the polycarbonate sheets with scratch-resistant coating systems Test specimens were produced as follows with the coating compositions obtained:

The injection-molded sheets of polycarbonate were cleaned with isopropanol and, where appropriate, primed by flooding with a primer solution.

The primer solution was superficially dried and, in the case of the primer of example 3, then additionally subjected to a heat treatment at 130° C. for half an hour.

The primed polycarbonate sheets were then flooded with the scratch-resistant coating composition (example 1, 2, 4). Priming was omitted for the scratch-resistant coating composition of example 6. The time for evaporation in air for dust drying was 30 minutes at 23° C. and 53% relative atmospheric humidity. The dust-dry sheets were heated in an oven at 130° C. for 30 to 60 minute and then cooled to room temperature.

Application of the Non-Fogging Top Layer

After curing had taken place, the coated sheets were stored at room temperature for two days. Thereafter, the non-fogging top layer is applied by flaming with the FTS 401 apparatus from Arcotec, Mönsheim, Germany. The belt speed was 20 m/min and the amount of air was 120 and the amount of gas 5.5 l/min. The apparatus combination FTS 201D/99900017 was used for the silication.

Testing of the Coated Sheets

After storage at room temperature for two days, the following surface properties were determined on these sheets:

Surface tension and water contact angle in accordance with DIN EN 828

Polar content of the surface tension according to equation (8) in “Einige Aspekte der Benetzungstheorie und ihre Anwendungen auf die Untersuchung der Veränderung der Oberflächeneigenschaften von Polymeren” in Farbe und Lack, volume 77, no. 10, 1971, p. 997 et seq.

Model greenhouse test

Steam test

Model Greenhouse Test

The coated polycarbonate sheets were fixed to the roof of a model greenhouse at an angle of 60° with the coated side downwards, so that it was possible to compare the water-spreading action by observing the formation of droplets. Water was evaporated in the model greenhouse with a heat source, such that a temperature of 50° C. and an atmospheric humidity of 100% were established.

The sheets were left under these conditions for 6 h and then heated at 40° C. in a dry heating cabinet for 4 h. The procedure in the model greenhouse and in the heating cabinet was then repeated, always in alternation, until the water-spreading effect disappeared (which may be seen by the formation of droplets on the sheet). The number of cycles before droplet formation occurs was stated as a criterion of the life of the non-fogging layer.

Steam Test (100° C.)

The steam test was carried out as a further test. In this, the coated polycarbonate sheets were exposed to a hot closed-off steam atmosphere at 100° C. The time at which the water-spreading effect disappeared and the first formation of drops took place was observed.

All the non-fogging layers prepared according to the invention were still functional even after 3 hours.

The results of the evaluations are shown in table 1.

TABLE 1

| | | | | Non-fogging top layer | | | | |
|---|---|---|---|---|---|---|---|---|
| Example | | Scratch-resistant | Flaming | | Water contact | Greenhouse | Surface | Polar |
| no. | Primer | lacquer | passes^{a)} | Addition^{b)} | angle | cycles | tension | content |
| 7 | Example 5 | Example 4 | 0 | none | >70° | 0 | 27 nM/m | 12% |
| 8 | Example 5 | Example 4 | 1 | TEOS | <10° | >80 | 66 mN/m | 44% |
| 9 | Example 5 | Example 4 | 2 | TEOS | <10° | >80 | 66 nM/m | 44% |
| 10 | Example 5 | Example 4 | 3 | TEOS | <10° | >80 | 66 nM/m | 44% |
| 11 | Example 5 | Example 4 | 2 | none | <20° | 0 | 66 nM/m | 42% |
| 12 | Example 3 | Example 2 | 0 | none | >70° | 0 | 34 nM/m | 15% |
| 13 | Example 3 | Example 2 | 1 | TEOS | <10° | 14 | 65 nM/m | 46% |
| 14 | Example 3 | Example 2 | 2 | TEOS | <10° | 14 | 65 nM/m | 47% |
| 15 | Example 3 | Example 2 | 3 | TEOS | <10° | 30 | 65 nM/m | 48% |
| 16 | Example 3 | Example 2 | 2 | none | <20° | 1 | 52 nM/m | 35% |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. A process for the production of a layer system that includes a substrate (S), one or more scratch-resistant layers (SR) and a non-fogging top layer (T), comprising
(a) applying one or more coating compositions to a substrate (S), the coating composition comprising a polycondensate, that is a product of the sol-gel process and based on at least one silane, and is at least partial cured to form a scratch-resistant layers (SR);
(b) subjecting the surface of the exposed scratch-resistant layer (SR) to flaming with simultaneous deposition of a layer which substantially comprises an oxidic compound of silicon, aluminium, titanium, indium, zirconium, tin and/or cerium by addition of compounds of silicon, aluminium, titanium, zirconium, tin and/or cerium into the fuel gas/air mixture to produce a non-fogging top layer (T).

2. The process according to claim 1, wherein the scratch-resistant layers (SR) is a polycondensate based on methylsilane.

3. The process according to claim 1, wherein the scratch-resistant layers (SR) comprises a polycondensate, prepared by the sol-gel process, of substantially 10 to 70 wt. % silica sol and 30 to 90 wt. % of a partly condensed organoalkoxysilane in an aqueous/organic solvent mixture.

4. The process according to claim 1, wherein the scratch-resistant layer (SR) comprises a polycondensate, prepared by the sol-gel process, based on at least one silane which has an epoxide group on a non-hydrolyzable substituent,

5. The process of claim 4 wherein the scratch-resistant layer further comprise particles and a curing catalyst selected from the group consisting of Lewis base, titanium alcoholate, zirconium alcoholate and aluminium alcoholate.

6. The process according to claim 1, wherein the scratch-resistant layers (SR) is a polycondensate based on at least one silyl acrylate.

7. The process according to claim 1, wherein the scratch-resistant layers (SR) comprises methacryloxypropyltrimethoxysilane and AlO(OH) nanoparticles.

8. The process according to claim 1, wherein the scratch-resistant layers (SR) is a polycondensate based on at least one multifunctional cyclic organosiloxane.

9. The process according to claim 1, wherein the scratch-resistant layers (SR) is a polycondensate based on a silane having four hydrolyzable groups.

10. The process according to claim 1 wherein subjecting the surface to flaming is carried out after complete curing of the scratch-resistant layer (SR).

11. The process according to claim 1 wherein the flaming is carried out in a flaming installation.

12. The process according to claim 11 wherein the flaming installation has a flow-through speed of 1 to 20 m/min.

13. The process according to claim 1 wherein the substrate (S) comprises plastic.

14. The process according to claim 1 wherein the scratch-resistant layer (SR) has a thickness of 0.1 to 30 μm.

15. The process according to claim 1 wherein the non-fogging layer (T) has a thickness of less than 1 μm.

16. The process according to claim 1 wherein a primer layer (P) is formed between the substrate (S) and scratch-resistant layer (SR).

17. The process according to claim 1 wherein the scratch-resistant layer (SR) are dried at a temperature of >20° C.

18. Process according to one of the preceding claims claim 1, characterized in that to produce the non-fogging top layer (T), particularly readily vaporizable organic compounds or aerosols are used.

19. Process according to one of the preceding claims claim 1, characterized in that silicon compounds, in particular tetraalkoxysilanes, are preferably used to produce the non-fogging top layer (T).

20. The process according to claim 1 wherein the non-fogging top layer (T) has a water contact angle of less than 40 degrees and a polar content of the surface tension of more than 20 mN/m

21. The layer system obtained by the process according to claim 1.

22. The layer system of claim 21 wherein the substrate is glass.

23. The layer system of claim 21 wherein the substrate is thermoplastics.

24. The layer system of claim 21 wherein the substrate is transparent.

25. The layer system of claim 23 wherein the thermoplastic is selected from the group consisting of polymethyl methacrylate, polystyrene, polyvinyl chloride, polyurethane and polycarbonate.

26. The layer system of claim 15 wherein the thermoplastic is polycarbonate.
